(19) United States
(12) Patent Application Publication
(10) Pub. No.: US 2026/0310556 A1
(43) Pub. Date: Oct. 8, 2026

(54) TECHNIQUES FOR GENERATING AND IMPLEMENTING DATA SECURITY IN A NETWORK

(71) Applicant: T-Mobile USA, Inc., Bellevue, WA (US)

(72) Inventors: Anil Kumar Mariyani, Ashburn, VA (US); Chris Jensen, Snoqualmie, WA (US)

(21) Appl. No.: 19/170,769

(22) Filed: Apr. 4, 2025

(51) Int. Cl. G06F 11/14; H04L 9/40

(52) U.S. Cl. CPC G06F 11/1464; H04L 63/0209; H04L 63/108

(57) ABSTRACT

Techniques are described herein for implementing a secure data repository. In embodiments, such techniques may comprise maintaining, in a first data repository within a network, network data accessible to one or more components of the network, performing a first backup process to generate a first copy of the network data in a second data repository, and performing a second backup process to generate a second copy of the network data in a third data repository at a secure site. The techniques may further comprise detecting a failure event relating to at least the first data repository and establishing a connection between the one or more components of the network and the third data repository, wherein the one or more components retrieve data from the third data repository instead of from the first data repository.

### BACKGROUND

Security is a critical issue facing cellular networks. Cellular networks typically provide data and voice services to a number of mobile devices operating in a geographic region. However, in order to provide those services, the cellular network may require access to a data repository that manages subscriber and service data. If that data repository becomes compromised (e.g., corrupted, deleted, locked down, etc.), the cellular network may be unable to provide those data and voice services. Furthermore, any corruption introduced to one data repository may be replicated to other data repositories operating on the cellular network.

Given the connected nature of cellular networks, there is a risk, however minimal, that a malicious actor may gain access to the data repository, either via remote access or physical access. Such an event poses a significant danger to the cellular network. In one example, upon gaining access, a malicious actor may attack the data repository and completely wipe out one or more entries. In another example, upon gaining access, a malicious actor may lock the repository to prevent read and write operations from being performed.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example network architecture for a system in which a network is capable of implementing a secure data repository in accordance with embodiments.

FIG. 2 depicts a block diagram illustrating a system in which a secure data repository may be implemented in a remote location to provide increased system stability in accordance with embodiments.

FIG. 3 depicts a flow diagram illustrating a process for updating data stored at a remote secure location in accordance with at least some embodiments.

FIG. 4 depicts a flow diagram illustrating a process for accessing data stored at a remote secure location in accordance with at least some embodiments.

FIG. 5 depicts a flow diagram illustrating an exemplary process for generating and implementing a secure data repository in accordance with at least some embodiments.

FIG. 6 depicts a block diagram illustrating interactions that may occur between various components of the system during a failover event in accordance with embodiments.

FIG. 7 shows an example computer architecture for a computing device capable of executing program components for implementing the functionality described above.

### DETAILED DESCRIPTION

Techniques are described herein for generating and implementing a secure data repository for a network system. In embodiments, subscriber data used in operation of a network is maintained in a data repository that can be accessed by a number of core components operating on the network. At periodic intervals, the data maintained in that data repository is copied to a local backup (e.g., redundant) repository. The local backup repository is then isolated (e.g., the connection between it and the data repository is severed).

A secure repository maintained at a secure site then initiates a second backup process with the isolated local backup. The second backup process is performed via a secure firewall implemented at the secure site, which causes a connection to be established between the secure repository and the local backup during a specified time period. During this second backup process, airgap procedures may be maintained to prevent access to the secure repository by any malicious actors.

Upon detecting a failure event in which a data repository is determined to have become corrupted or unavailable, a connection from one or more network components to that data repository may be replaced with a connection to the secure repository instead. Additionally, each of the transactions performed on the data repository since the secure data repository was created may be replayed to approximate a current state of the data repository. For example, where a secure repository was created 10 hours prior, a network node that performs billing functions may replay all the billing transactions that have occurred in the last 10 hours. The network components are then able to use (e.g., read/write) data from the secure repository in lieu of the current (corrupted or unavailable) repository.

Embodiments of the disclosure provide for a number of advantages over conventional systems. For example, embodiments of the disclosed system allow for data to be immunized from corruption at a secure (and secret) site so that services can be restored in a very short amount of time upon detection of a failure event in which a data repository has become corrupted/unavailable. Embodiments also allow network services to be recovered in the event that a malicious actor gains physical control of a facility that houses network resources.

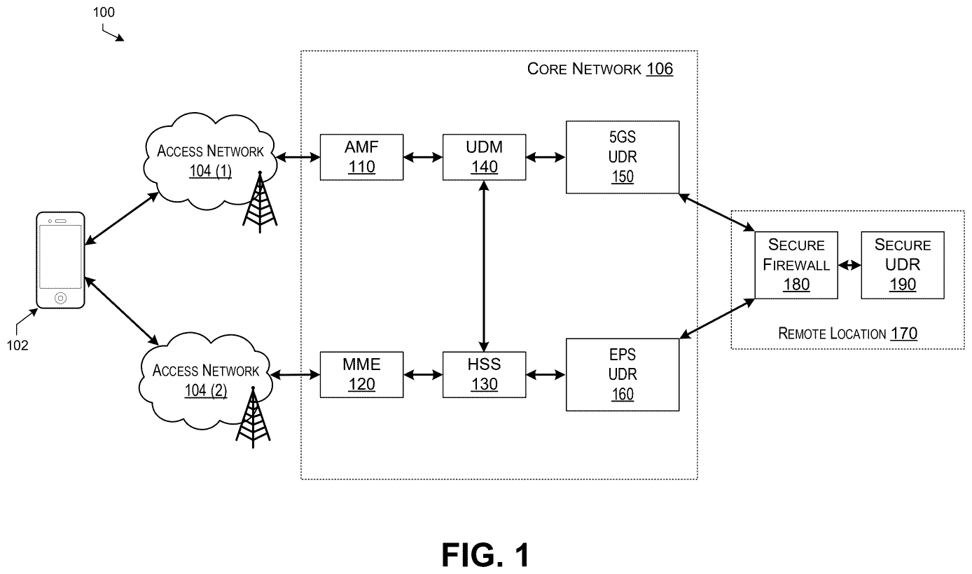

FIG. 1 illustrates an example network architecture 100 for a system in which a network (e.g., a cellular network) is capable of implementing a secure data repository in accordance with embodiments. The architecture 100 may include one or more user equipment (UE) 102 capable of connecting to one or more access networks 104 in order to communicate with a core network 106, which might be a packet core network (PCN) and/or an IP multimedia subsystem (IMS) network.

In embodiments, a UE 102 connecting to the system may be capable of doing so using access networks that operate with different access technologies. For example, the UE 102 may be capable of connecting to both an access network 104(1) and an access network 104(2), where both of the access networks 104(1) and 104(2) can provide ingress/egress to the system but operate using different technology standards. For example, access network 104(1) may operate using a 5G technology standard, whereas access network 104(2) may operate using a 4G technology standard.

The access networks 104(1) and 104(2) may be compatible with one or more radio access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunication System (UMTS) technology, WiMAX technology, Wi-Fi technology, and/or any other previous or future generation of radio access technology. Likewise, the access network may use any suitable cellular communications protocols, including a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a New Radio (NR) protocol, and the like.

The access networks 104(1) and 104(2) may include various types of base stations, for example, 2G base stations and/or 3G NodeBs that are associated with GSM and CDMA access networks, e-node Bs (eNBs) that are associated with an LTE access network also known as an Evolved UMTS Terrestrial Radio Access Network (E-UTRAN), or gNBs or new radio (NR) base stations that are associated with a 5G access network. In some cases, even when the access networks 104 (1 and 2) operate using different technology standards, both of those access networks may be implemented within a single base station.

In embodiments, each of the access networks 104 (1) and 104 (2) may operate using a different technology standard. For example, the access network 104 (1) may operate using a 5G technology standard whereas the access network 104 (2) may operate using a 4G technology standard. In such embodiments, both access networks 104 (1 and 2) may be available to the UE 102. The UE 102 may prioritize the 5G connection and may initially connect to the core network 106 via the access network 104 (1). However, the access network 104 (2) may become unavailable (e.g., oversubscribed, disconnected, or otherwise unavailable) at a later time and the UE 102 may automatically switch its connection to the access network 104 (2). In the architecture 100, an access network 104 (1) operating using a 5G technology standard may connect to the core network 106 via a node that provides an Access and Mobility Management Function (AMF) 110. In contrast, an access network 104 (2) operating using a 4G technology standard may connect to the core network 106 via a connection enabled through a Mobility Management Engine (MME) 120.

An AMF 110 handles registration of the UE 102 within a 5G network. The AMF 110 performs authentication services for the UE 102 and authorizes its access to 5G services. In addition, the AMF 110 may track location data for the UE 102 and manages its mobility (e.g., handoffs) within the 5G network. Note that while architecture 100 depicts only an AMF 110 in communication with access network 104 (1), the 5G network would include a number of other components for providing functionality that are not shown.

The MME 120 is the control plane node of a PCN and is located at its edge. The MME 120 manages user equipment session states and authenticates and tracks user equipment. The MME may communicate with one or more components of the core network 108, such as a home subscriber service (HSS) 130 for user equipment authentication. The MME's mobility function enables user equipment to access a core network. Among its other functions, the MME selects gateways to enable cellular communication service for each connecting user equipment.

The MME 120 may be implemented within an Evolved packet core network. An evolved packet core (EPC) network is a PCN framework for providing converged voice and data services on a fourth generation (4G) long-term evolution (LTE) cellular network. EPC comprises several network nodes which handle traffic and provide functions such as session management, mobile management, authentication and quality of service (QoS). Some of the primary nodes in EPC are the MME 120, the serving gateway (SGW), the packet gateway (PGW), the policy and charging rules function (PCRF), and the home subscriber service (HSS). Various additional components that may be included in the EPC architecture are omitted from FIG. 1 for simplicity.

In embodiments, the AMF 110 may be in communication with a node that performs a Unified Data Management (UDM) function. The UDM 140 may perform a central control plane function responsible for storing and managing subscriber data, authentication, and related information. It also acts as a front end to the 5GS Unified Data Repository (UDR) 150. A UDR may be a data repository that manages subscriber data that is used in operation of a network (e.g., a cellular network). In some non-limiting examples, such subscriber data may include location information, cell identities (e.g., GMLC), user equipment identifiers (e.g., IMSI/MSISDN/SUPI/SUCI), or any other suitable information.

The HSS 130 is typically a master user database that supports the core network nodes that handle the calls/sessions. It contains user profiles, performs authentication and authorization of the user, and can provide information about the physical location of a user. A user profile may be associated with each UE 102 and may contain information about the current user. Such information may be downloaded by the S-CSCF assigned to the user when the user is registered on the network. The S-CSCF may typically receive that information in a User-data Attribute Value Pair (AVP) format. The HSS includes a database of subscriber information and user authentication details, as well as information for use in configuring calls and IP sessions. Multiple HSS nodes can optionally be synchronized to ensure proper cooperation and consistent function. The HSS 130 may also act as a front end to an evolved packet system (EPS) Unified Data Repository (UDR) 160.

A UDR, such as 5GS UDR 150 or EPS UDR 160, may be a converged repository, which is used by 5G Network Functions to store the data. As depicted, the core network 106 may maintain multiple UDRs, with each UDR storing subscriber data related to a different type of access network (e.g., 5G or LTE).

In embodiments, a secure backup may be maintained at a remote location 170. In some embodiments, a location (and in some cases even the existence) of such a secure backup may be kept confidential. In embodiments, the secure backup may include at least a secure firewall 180 that managed access to a secure UDR 190. The secure UDR 190 may be updated periodically based on the current information stored in each of the UDRs (e.g., 150 or 160) that are operating within the core network 106.

The network architecture 100 as illustrated in FIG. 1 may be part of a telecommunication network of a wireless service provider such as, T-Mobile, AT&T, Verizon Wireless, etc. The telecommunication network may include one or more core networks including the core network 106, one or more PCNs, and one or more access networks including the access networks 104(1) and 104(2) and through which a UE 102 can connect to the core network 106.

It should be understood that the network scenario shown in FIG. 1 is for the purpose of illustration. In various real-world scenarios, telecommunication networks or one or more subsystems of a telecommunication network can be logically divided into a number of regions. Each of the regions may logically include a packet core network and an IMS network. Additionally, each of the depicted components may be configured as a centralized component of the telecommunication network accessible to all logically divided IMS networks.

The techniques discussed herein may be implemented in the telecommunication network using one or more of protocols including but are not limited to Ethernet, 3G, 4G, 4G LTE, 5G, or any combination thereof. The techniques may also optionally be implemented in the telecommunication network using 6G and/or future radio access technologies.

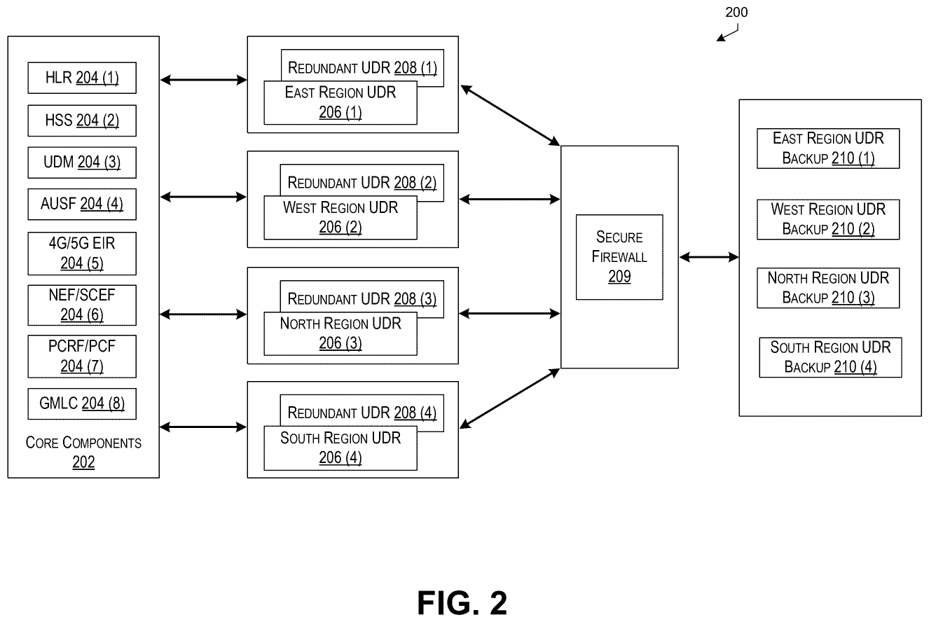

FIG. 2 depicts a block diagram illustrating a system in which a secure data repository may be implemented in a remote location to provide increased system stability in accordance with embodiments. In the depicted system 200, a number of core components 202 may interact with a respective regional UDR 206. Each regional UDR 206 may be in communication with a respective redundant UDR 208 that acts as a local backup for that regional UDR. Each redundant UDR 208 may be in communication, via a secure firewall 209, with a respective remote regional UDR backup 210.

In embodiments, each of a number of core components 202 may interact with data stored in a regional UDR in order to provide services to user equipment operating within a respective region. A region may represent a portion of a geographic area, such as a country or continent. In embodiments, an area may be partitioned into multiple regions that are served by an East region UDR 206 (1), West region UDR 206 (2), North region UDR 206 (3), or South region UDR 206 (4) respectively. Data used to service a particular user equipment may be retrieved from a regional UDR associated with a region in which the user equipment is currently located or a home region for the user equipment.

In embodiments, core components 202 may include, but are not limited to, computing nodes that perform services related to a Home Location Register (HLR) component 204 (1), a Home Subscriber Server (HSS) component 204 (2), a Unified Data Management (UDM) component 204 (3), Authentication Server Function (AUSF) component 204 (4), Equipment Identity Register (EIR) component 204 (5), Network Exposure Function (NEF) or Service Capability Exposure Function (SCEF) component 204 (6), Policy and Charging Rules Function (PCRF) or Policy Control Function (PCF) component 204 (7), or a Gateway Mobile Location Center (GMLC) component 204 (8).

A HLR component 204 (1) may be a central database within a mobile network that stores crucial information about each subscriber, including their phone number, service details, and current location, allowing for call routing and other network functions like roaming across different cell towers.

As noted above, a HSS component 204 (2) may be a master user database that supports the core network nodes in order to perform authentication and authorization of a user or provide information about the physical location of a user. The HSS component 204 (2) may be an example of the HSS 130 as described above in relation to FIG. 1.

As noted above, a UDM component 204(3) may perform a central control plane function responsible for storing and managing subscriber data, authentication, and related information. The UDM component 204 (3) may be an example of the UDM 140 as described above in relation to FIG. 1.

An AUSF component 204 (4) is a component responsible for verifying user identity, validating subscription data, determining the appropriate security context, and supporting authentication and key agreement processes.

An EIR component 204 (5) provides an access point for authentication of mobile devices in the network. More particularly, the EIR component 204 (5) supports black, grey, and/or white-lists for individual user equipment identifiers (e.g., IMEIs, 5G PEIs as well as IMEI/PEI ranges). The EIR component 204 (5) supports user equipment registration to allow other core network functions to be provided by a mobile core.

A NEF/SCEF component 204 (6) provides network functions that securely expose core network capabilities and data to external applications and developers. The NEF/SCEF allows data delivery and supports security features at the network border.

A PCRF/PCF component 204 (7) supports data flow detection, policy enforcement and flow-based charging. The PCRF also manages QoS and defines charging based on user subscriptions are applicable to user equipment. The PCRF ensures that users receive services and are charged for them according to their contracts.

A GMLC component 204 (8) acts as a central point for accessing and managing location information of mobile devices within a Public Land Mobile Network (PLMN). A GMLC may be a network node that facilitates location-based services (LBS) by providing access to mobile device location information.

In embodiments, data stored in a regional UDR 206 may be copied to a locally positioned redundant UDR 208 (e.g., on a periodic basis) to create a local backup. Once the data has been copied to the redundant UDR, that data may be provided to a remote secure location. Notably, the data is filtered by a secure firewall 209 and provided to a respective regional UDR backup 210. In embodiments, a separate regional UDR backup may be maintained at the remote secure location for each of the respective regional UDRs 206. For example, the remote secure location may store an East Region UDR Backup 210 (1), West Region UDR Backup 210 (2), North Region UDR Backup 210 (3), and South Region UDR Backup 210 (4) corresponding to the regional UDRs 206.

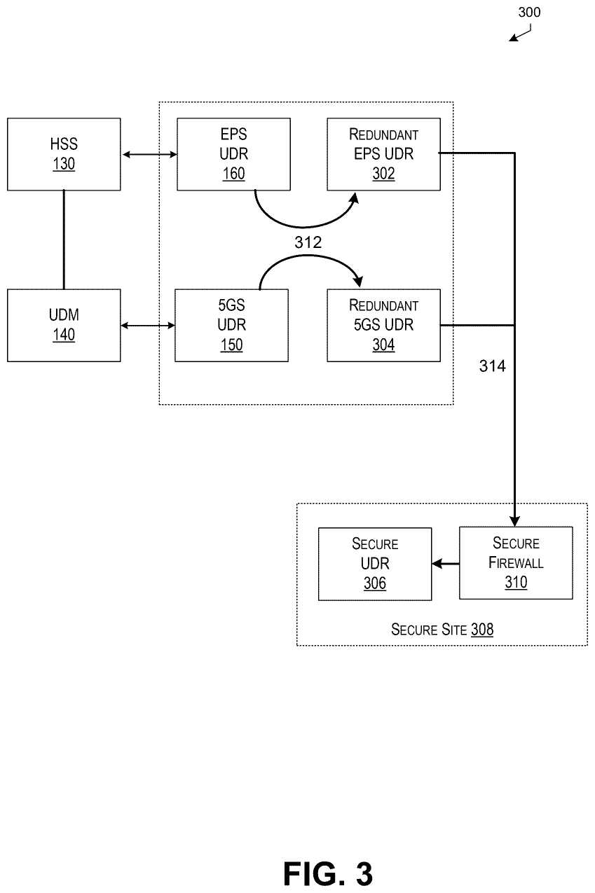

FIG. 3 depicts a flow diagram illustrating a process for updating data stored at a remote secure location in accordance with at least some embodiments. The process 300 may involve interactions between one or more components as described throughout the disclosure. As depicted, various components may be in communication with a UDR that maintains data that can be used by the various components to provide services related to the network.

In embodiments, the process 300 may involve interactions between a HSS 130 and/or a UDM 140 in communication with a respective UDR. For example, as noted with respect to FIG. 1 above, a HSS 130 may be implemented within a network that operates using LTE protocols whereas a UDM 140 may be implemented within a network that operates using 5G protocols. Accordingly, a HSS 130 component may be in communication with an Evolved Packet System (EPS) UDR 160 that services the network that operates using LTE protocols whereas a UDM 140 may be in communication with a Fifth Generation System (5GS) UDR 160 that services the network that operates using 5G protocols.

Each of the UDRs 150 and 160 may be in communication with a respective local backup data repository, as a redundant UDR. Notably, the EPS UDR 160 may be in communication with a redundant EPS UDR 302 whereas the 5GS UDR 150 may be in communication with a redundant 5GS UDR 150.

Each of the Redundant UDRs 302 and UDR 304 may be accessible by a respective secure UDR 306 located at a remote secure site 308. The secure site 308 may be secured via a secure firewall 310 that manages access to the secure UDR 306. As would be recognized by one skilled in the art, the secure firewall 310 may be any combination of hardware and software components that serve to filter incoming and/or outgoing network traffic to the secure site 308. The secure firewall 310 may limit which entities may or may not access the secure site 308 and under what conditions such access may be granted.

In operation, a backup process 312 may be performed on a periodic basis (e.g., at a predetermined time) in which the data stored in a UDR (150 and/or 160) is copied/replicated to a respective redundant UDR (302 and/or UDR 304). In some cases, multiple redundant UDRs are maintained locally (e.g., in geographic proximity to the UDR), with each relating to a respective age of the data. For example, a first redundant UDR may receive a copy of the data included in the UDR on a daily basis whereas a second redundant UDR may receive a copy of the data included in the UDR on a weekly basis.

During a separate event, and preferably after the backup process 312 has been performed, the secure UDR 306 may perform a secure backup process 314. In embodiments, the secure backup process 314 may be initiated by the secure UDR 306. For example, the secure firewall 310 may open a connection (e.g., IP/port) between the secure UDR 306 and the redundant UDR 302 or UDR 304 for a specific duration and/or during a specific time period. Note that during this time period, an “airgap” may be maintained in that the redundant UDR 302 or UDR 304 should not have an active connection with the live UDR 150 or 160. In some cases, the redundant UDR may be isolated from any other network connections while the backup process 314 is being performed. While that connection is open, the secure UDR 306 retrieves/downloads all of the data stored in the redundant UDR. Once the backup process 314 has been completed, or once the specified duration/time period has elapsed, the connection is shut down by the secure firewall 310.

In some embodiments, multiple versions of the secure UDR 306 may be maintained in relation to each live UDR (150 or 160). For example, a first version of the secure UDR 306 may receive a copy of the data included in the redundant UDR each day, a second version of the secure UDR 306 may receive a copy of the data included in the redundant UDR at the beginning of the week, a third version of the secure UDR 306 may receive a copy of the data included in the redundant UDR on a bi-weekly basis, a fourth version of the secure UDR 306 may receive a copy of the data included in the redundant UDR at the beginning of the month, etc. In embodiments, a particular version of the multiple versions of the secure UDR 306 may be selected and implemented prior to the secure UDR being accessed by various network components.

In embodiments, the secure UDR 306 is reliant on a redundant (e.g., backup) UDR (302 or 304) maintained at a production site alongside a respective production UDR (150 or 160). In embodiments, daily automated secure backups shall be performed between active production sites to secure UDR site using secure airgap technology. When implementing airgap technology, direct or indirect connections between a secure UDR and other network components is prevented. Systems, networks, and data can be isolated to prevent unauthorized intrusion.

The secure firewall 310 may be a specialized (e.g., smart) firewall that opens the required IP/ports for connectivity between configured source & destination only for specific duration and/or during a specific time period. Using airgap technology, the secure UDR 306 may act as a master by initiating the backup process 314 with the redundant UDR at the production site according to a predefined backup cadence. Production sites may be prevented from transferring backup data to any other entity whether inside or outside of the network.

In embodiments, a backup cadence may be defined in such a way that an operator is able to use any available backup copy based on threat detection. For example, if the UDR is corrupted on a 9^{th} day of the month but a network cyber security team identifies it on the 18^{th} day of the month, an operator should have the flexibility to restore a backup data copy from the 1^{st} day of the month before taking the secure UDR 306 live for customer traffic. In a non-limiting example, an illustrative backup cadence may involve collecting backup data at multiple predetermined dates/times that include multiple daily backups, multiple weekly backups, multiple fortnight copies, and/or multiple monthly backups. Additionally, a separate retention policy may dictate a length of time that each type of backup data may be overwritten/retained on a secure UDR. A nonlimiting example of such a retention policy may be implemented as represented by the below Table 1.

TABLE 1

| Backup Type | Retention Period |
|---|---|
| Daily | 7 days in a sequence |
| Weekly | Every Sunday |
| Bi-Weekly | 1st and 15th of each month |
| Monthly | 1st of every other month |

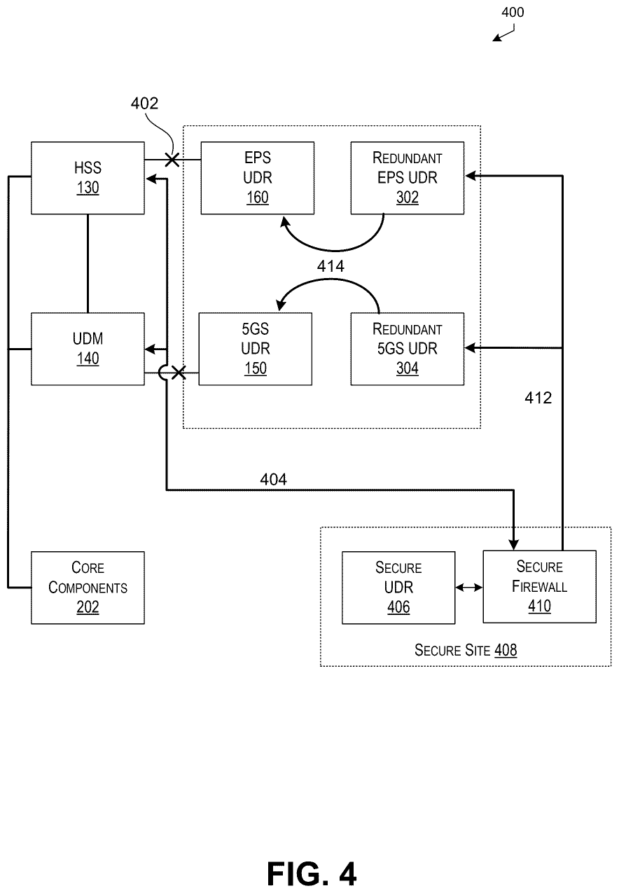

FIG. 4 depicts a flow diagram illustrating a process for accessing data stored at a remote secure location in accordance with at least some embodiments. Like process 300, the process 400 may involve interactions between one or more components as described throughout the disclosure. As depicted, various components may be in communication with a UDR that maintains data that can be used by the various components to provide services related to the network.

As discussed in relation to the process 300 above, the process 400 may involve interactions between a HSS 130 and/or a UDM 140 in communication with a respective UDR. For example, a HSS 130 may be implemented within a network that operates using LTE protocols whereas a UDM 140 may be implemented within a network that operates using 5G protocols. Accordingly, a HSS 130 component may initially be in communication with an EPS UDR 160 that services the network that operates using LTE protocols whereas a UDM 140 may initially be in communication with a 5GS UDR 160 that services the network that operates using 5G protocols.

In embodiments, each of the HSS 130 and the UDM 140 may act as a in interface between a respective UDR and one or more core components 202 of the network. Some examples of the core components 202 of the network are described in relation to FIG. 2 above.

During operation a failure event may be detected on the network. In embodiments, a failure event may be any condition in which an integrity of the data repository is determined to have been compromised. In some cases, this may involve detecting that one or more data entries has become missing or corrupted. In some cases, this may involve detecting that the read/write operations are no longer allowed in the data repository. In some cases, a failure event may correspond to a malicious actor gaining physical access to a site at which the data repository is stored.

Upon detecting a failure event in relation to a UDR, at least a portion of the data within that UDR may be replaced with the data within the respective local redundant UDRs. For example, upon making a determination that some data within a UDR was corrupted two days in the past, that data may be replaced with corresponding data from a local redundant UDR that was copied a minimum of two days ago. However, in the event that the data was found to be corrupted a long time before its discovery, or in the event that the data is found to be unrecoverable from within the local redundant UDR, that may not be possible. Alternatively, it is possible that a hostile and unauthorized force may gain physical access to, or cause to be destroyed, the UDR as well as local redundant UDRs. In such cases, recovery from the redundant UDR may not be possible.

Upon determining that recovery from a redundant UDR is not feasible or possible, a connection 402 between the core components 202, HSS 130, and/or UDM 140 and a respective UDR may be severed. Instead, each of the core components 202, HSS 130, and/or UDM 140 may be redirected over a new connection 404 to the secure UDR 406. As noted elsewhere, the secure UDR 406 may be located at a secure site 408, access to which may be managed by a secure firewall 410. In some cases, the secure firewall 410 may be configured to open access to the secure UDR 406 upon detecting the failure event.

In embodiments, one or more core components 202 may be configured to access the secure UDR over a connection 404. In some cases, the core components may be provided with login/access credentials that can be used to access the secure UDR. In such embodiments, the login/access credentials may allow the respective core components to bypass the secure firewall 410. As noted above, the connection 404 may be established between each of the core components 202 and the secure UDR 406. To do this, each of the core components 202 may replace an address (e.g., an IP address or port) associated with the current UDR (e.g., UDR 150 or 160) with an address associated with the secure UDR 406. Such a replacement may be performed manually (e.g., performed by an administrator or other user) or automatically (e.g., without human interaction).

Prior to enabling the secure UDR 406 on the network, each of the core components 202 may replay recent transactions to update the secure UDR. More particularly, each of the core components 202 may replace its respective transactions that have occurred over a period of time since the data for the secure UDR 406 was copied. For example, given that the secure UDR 406 was last updated 3 days ago, each of the core components would replay its respective transactions from the last 3 days. The transactions would be replayed in chronological order in order to replicate a predicted current state of the unavailable UDR.

Once the data in the secure UDR 406 has been updated, that data is made available to the core components 202 for use in operations. During operation, the core components 202 continue to perform their typical functions but direct all data requests to the secure UDR 406 located at the secure site 408 rather than to a respective UDR 150 or 160. In the course of operation, the core components may perform any suitable read/write operations within the secure UDR 406.

In embodiments, UDRs 150 and 160 may be restored from data included in the secure UDR 406. In such cases, a connection 412 may be established between the secure UDR 406 and one or more of redundant UDR 302 and UDR 304. In such cases, each redundant UDR with which the connection 412 is established may be isolated from other network components (e.g., UDR 150 or 160). In other words, a connection between the redundant UDR and may be severed as long as the connection 412 remains established. Data maintained within the secure UDR 406 may be copied to the redundant UDR over the connection 412.

Once the data from the secure UDR 406 has been copied over to the redundant UDR, the connection 412 may be severed. Additionally, in cases where transactions have not been replayed previously, each of the transactions that have been performed by the core components 202 since the secure UDR 406 was copied are replayed on the redundant UDRs in order to bring the data within the redundant UDRs up to date. Once that data has been updated, the connection 414 between the redundant UDRs and their respective UDR 150 or 160 may be reestablished and the data in the redundant UDR 302 or UDR 304 may be copied over to the respective UDR 150 or 160. Once the UDR 150 or 160 has been restored, the connection 402 may be reestablished and the core components 202 may be redirected away from the secure UDR 406 and back to the respective UDR 150 or 160.

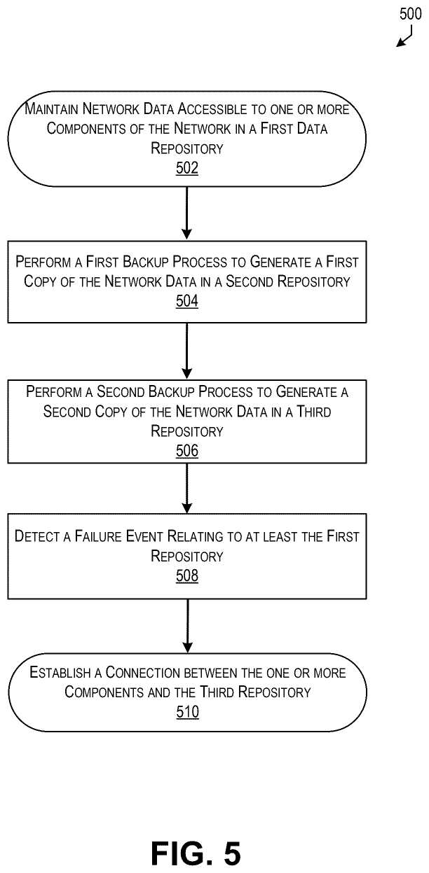

FIG. 5 depicts a flow diagram illustrating an exemplary process for generating and implementing a secure data repository in accordance with at least some embodiments. The process 500 may be performed by a mobility management entity (MME), such as the MME 120 as described in relation to FIG. 1 above.

At 502, the process 500 may involve maintaining, in a first data repository within a network, network data accessible to one or more components of the network. As noted elsewhere, the first data repository may be a Unified Data Repository (UDR) that maintains information relevant to the operation of a network.

At 504, the process 500 may involve performing, by a computing node operating within the network, a first backup process to generate a first copy of the network data in a second data repository. In embodiments, the second repository includes a backup repository that is geographically local to the first repository.

At 506, the process 500 may involve performing, by a second computing node operating at a secure site, a second backup process to generate a second copy of the network data in a third data repository. In embodiments, the third repository may be maintained at a secure location that is geographically remote from a location of the first repository. In embodiments, the second backup process may be performed while the second repository is isolated from the first repository. In some cases, multiple versions of the network data, the multiple versions corresponding to states of the network data at different dates.

Access to the third repository may be managed by a secure firewall that prevents access to the third repository while the second backup process is not being performed and while no failure event has been detected. In embodiments, the second backup process is performed during a predetermined period of time during which the secure firewall has allowed access.

At 508, the process 500 may involve detecting a failure event relating to at least the first data repository. In embodiments, the failure event may be an event in which the first data repository has become corrupted or unavailable. In some cases, a failure event may be an event in which a malicious actor has gained physical access to the first data repository.

At 510, the process 500 may involve establishing a connection between the one or more components of the network and the third data repository. In embodiments, the one or more components may retrieve data from the third data repository instead of retrieving that data from the first data repository.

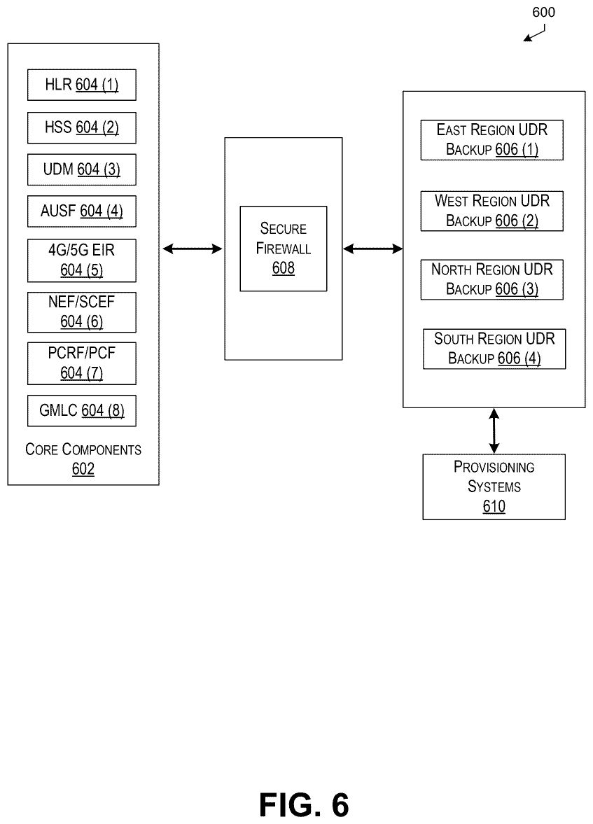

FIG. 6 depicts a block diagram illustrating interactions that may occur between various components of the system during a failover event in accordance with embodiments. As noted elsewhere, the system may include a number of core components 602 capable of interacting with one or more regional UDR backup 606 through a secure firewall 608. In some cases, the system may further include one or more provisioning systems 610 capable of communicating with the regional UDR backup 606.

Similar to the core components 202 as described above, core components 602 may include, but are not limited to, computing nodes that perform services related to a HLR component 604 (1), a HSS component 604 (2), a UDM component 604(3), AUSF component 604 (4), EIR component 604 (5), NEF or SCEF component 604 (6), PCRF or PCF component 604 (7), or a GMLC component 604 (8). In embodiments, the core components 602 may be configured to provide data & messaging services to user equipment operating on a network.

In embodiments, the one or more provisioning systems 610 may include Business Support System (BSS) and Customer Relationship Management (CRM) that perform provisioning activities that support activating services and managing configurations for customer-facing activities. In embodiments, the one or more provisioning systems 610 may be located behind the secure firewall 608, in that it is able to access a respective UDR backup directly.

As noted elsewhere, during typical network operations, the core components 602 of the network do not have any active connections to a regional UDR backup 606 housed at a secure site. Despite not having an active connection, each of the core components 602 may locally maintain an encrypted UDR site configuration. The encrypted UDR site configuration may or may not include pre-defined access credentials (e.g., usernames/passwords) that can be used to access the UDR backup 606 at the secure site.

In the event of a UDR corruption/breach, a configuration option may be implemented (e.g., via front-end applications) on the network core components 602 in order to redirect actions targeting that UDR to a respective UDR backup 606. For example, the encrypted UDR site configuration may be caused to be decrypted and implemented on a respective core component. In some cases, upon implementation of the UDR site configuration in this manner, a core component may be configured to accept an input of access credentials (e.g., a username and/or password) from a user (e.g., administrator) that may be used to access the secure UDR backup 606. By limiting access between the core components 602 and the secure UDR backup to only those communications that include valid access credentials, risks of that UDR backup being exposed to corruption can be mitigated.

When actions targeting a UDR are redirected to a respective UDR backup, each of the user equipment operating on the network that are being serviced by the core components may be forced to reestablish a respective connection. In order to reestablish a connection, that user equipment may be forced to re-register with the network, allowing the core components to smoothly establish new communication sessions and reallocate resources between the core components/user equipment.

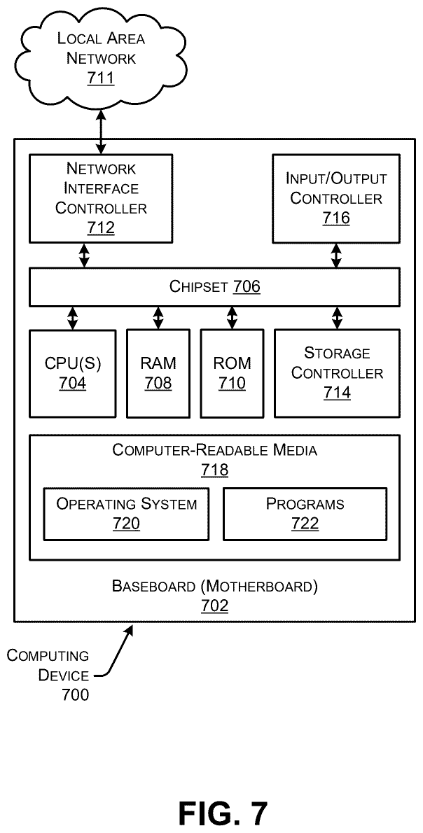

FIG. 7 shows an example computer architecture for a computing device 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computing device 700 may, in some examples, correspond to a physical server as described herein, and may comprise networked devices such as servers, switches, routers, hubs, bridges, gateways, modems, repeaters, access points, etc.

The computing device 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computing device 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computing device 700. The chipset 706 can further provide an interface to a computer-readable storage medium such as a read-only memory (“ROM”) 710 or non-volatile RAM (“NVRAM”) for storing basic routines that help to startup the computing device 700 and to transfer information between the various components and devices. The ROM 710 or NVRAM can also store other software components necessary for the operation of the computing device 700 in accordance with the configurations described herein.

The computing device 700 can operate in a networked environment using logical connections to remote computing devices and computer systems through a network, such as the network 711. The chipset 706 can include functionality for providing network connectivity through a NIC 712, such as a gigabit Ethernet adapter. The NIC 712 is capable of connecting the computing device 700 to other computing devices over the network 711. It should be appreciated that multiple NICs 712 can be present in the computing device 700, connecting the computer to other types of networks and remote computer systems.

The computing device 700 can be connected to a storage device 718 that provides non-volatile storage for the computer. The storage device 718 can store an operating system 720, programs 722, and data, which have been described in greater detail herein. The storage device 718 can be connected to the computing device 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computing device 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 can further read information from the storage device 718 by detecting the physical states or characteristics of one or more particular locations within the physical storage units.

In addition to the mass storage device 718 described above, the computing device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 700. In some examples, the operations performed by devices as described herein may be supported by one or more devices similar to computing device 700. Stated otherwise, some or all of the operations performed by an edge device, and/or any components included therein, may be performed by one or more computer device 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computing device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computing device 700.

In one embodiment, the storage device 718 or other computer-readable storage media is encoded with computer-executable instructions which, when loaded into the computing device 700, transform the computer from a general-purpose computing system into a special-purpose computer capable of implementing the embodiments described herein. These computer-executable instructions transform the computing device 700 by specifying how the CPUs 704 transition between states, as described above. According to one embodiment, the computing device 700 has access to computer-readable storage media storing computer-executable instructions which, when executed by the computing device 700, perform the various processes described above with regard to the other figures. The computing device 700 can also include computer-readable storage media having instructions stored thereupon for performing any of the other computer-implemented operations described herein.

The computing device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computing device 700 might not include all of the components shown in FIG. 7, can include other components that are not explicitly shown in FIG. 6, or might utilize an architecture completely different than that shown in FIG. 7.

As described herein, the computing device 700 may include one or more hardware processors (e.g., CPU 704) configured to execute one or more stored instructions. The processor(s) may comprise one or more cores. Further, the computing device 700 may include one or more network interfaces configured to provide communications between the computing device 700 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 711. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 722 may comprise any type of programs or processes to perform the techniques described in this disclosure. The programs 722 may comprise any type of program that cause the computing device 700 to perform techniques for communicating with other devices using any type of protocol or standard usable for determining connectivity. These software processors and/or services may comprise a routing module and/or a Path Evaluation (PE) Module, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, PE Module may also include computer executable instructions that, when executed by processor(s), cause computing device 700 to perform the techniques described herein. To do so, in some embodiments, PE Module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, PE Module may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
maintaining, in a first data repository within a network, network data accessible to one or more components of the network;
performing, by a computing node operating within the network, a first backup process to generate a first copy of the network data in a second data repository;
performing, by a second computing node operating at a secure site, a second backup process to generate a second copy of the network data in a third data repository;
detecting a failure event relating to at least the first data repository; and
upon detecting that the failure event has occurred, establishing a connection between the one or more components of the network and the third data repository, wherein the one or more components retrieve data from the third data repository instead of from the first data repository.

2. The method of claim 1, wherein the failure event comprises an event in which the first data repository has become corrupted or unavailable.

3. The method of claim 1, wherein the second backup process is performed while the second data repository is isolated from the first data repository.

4. The method of claim 1, wherein the second data repository comprises a backup repository that is geographically local to the first data repository.

5. The method of claim 1, wherein the third data repository is maintained at a secure location that is geographically remote from a location of the first data repository.

6. The method of claim 1, wherein access to the third data repository is managed by a secure firewall.

7. The method of claim 6, wherein the second backup process is performed during a predetermined period of time during which the secure firewall has allowed access.

8. The method of claim 7, wherein the secure firewall prevents access to the third data repository while the second backup process is not being performed and while no failure event has been detected.

9. The method of claim 1, wherein the third data repository comprises multiple versions of the network data, the multiple versions corresponding to states of the network data at different dates.

10. A network system comprising:
one or more processors; and
one or more non-transitory computer-readable media storing computer-executable instructions that, when executed by the one or more processors, cause the network system to perform operations comprising:
maintaining, in a first data repository within a network, network data accessible to one or more components of the network;
performing, by a computing node operating within the network, a first backup process to generate a first copy of the network data in a second data repository;
performing, by a second computing node operating at a secure site, a second backup process to generate a second copy of the network data in a third data repository;
detecting a failure event relating to at least the first data repository; and
upon detecting that the failure event has occurred, establishing a connection between the one or more components of the network and the third data repository, wherein the one or more components retrieve data from the third data repository instead of from the first data repository.

11. The network system of claim 10, wherein the failure event comprises an event in which the first data repository has become corrupted or unavailable.

12. The network system of claim 10, wherein the second backup process is performed while the second data repository is isolated from the first data repository.

13. The network system of claim 10, wherein the second data repository comprises a backup repository that is geographically local to the first data repository.

14. The network system of claim 10, wherein the third data repository is maintained at a secure location that is geographically remote from a location of the first data repository.

15. The network system of claim 10, wherein access to the third data repository is managed by a secure firewall and the secure firewall prevents access to the third data repository while the second backup process is not being performed and while no failure event has been detected.

16. The network system of claim 10, wherein the third data repository comprises multiple versions of the network data, the multiple versions corresponding to states of the network data at different dates.

17. One or more non-transitory computer-readable media storing computer-executable instructions that, when executed by one or more processors, cause the one or more processors to perform operations comprising:
maintaining, in a first data repository within a network, network data accessible to one or more components of the network;
performing a first backup process to generate a first copy of the network data in a second data repository;
performing a second backup process to generate a second copy of the network data in a third data repository;
detecting a failure event relating to at least the first data repository; and
upon detecting that the failure event has occurred, establishing a connection between the one or more components of the network and the third data repository, wherein the one or more components retrieve data from the third data repository instead of from the first data repository.

18. The one or more non-transitory computer-readable media of claim 17, wherein the operations further comprise severing a connection between the first data repository and the second data repository while performing the second backup process.

19. The one or more non-transitory computer-readable media of claim 17, wherein access to the third data repository is managed by a secure firewall and the secure firewall prevents access to the third data repository while the second backup process is not being performed and while no failure event has been detected.

20. The one or more non-transitory computer-readable media of claim 17, wherein the third data repository is maintained at a secure location that is geographically remote from a location of the first data repository.
